(19) United States
(12) Patent Application Publication
(10) Pub. No.: US 2019/0154235 A1
(43) Pub. Date: May 23, 2019

(54) LIGHT EMITTING DIODE REPLACEMENT FOR A FLUORESCENT LAMP

(71) Applicant: Ameritech LLC, Red Bank, NJ (US)

(72) Inventor: John N. Magno, Red Bank, NJ (US)

(21) Appl. No.: 16/099,002

(22) PCT Filed: May 4, 2017
(86) PCT No.: PCT/US2017/030956

§ 371 Date: Nov. 5, 2018

Related U.S. Application Data
(60) Provisional application No. 62/332,365, filed on May 5, 2016.

(51) Int. Cl. F21V 7/09; F21V 7/00; F21V 8/00

(52) U.S. Cl. CPC F21V 7/09; F21V 7/0016; F21Y 2103/10; G02B 6/0096; F21V 7/0041

(57) ABSTRACT

A luminaire. The luminaire includes a substrate, a plurality of discrete light sources, a cavity between a first body member and a second body member, and an aperture. The light sources emit a portion of light in a direction normal to the substrate. The first body member includes a protrusion which includes a second light reflective surface. All the light emitted by the light sources normal to the substrate first strikes the first light reflective surface. The second body member includes a recess which includes a second light reflective surface. The majority of the light emitted by the light sources normal to the substrate strikes the second light reflective surface after striking and being reflected from the first light reflective surface. The aperture is opposite the substrate and is positioned to allow light reflected from the second light reflecting surface to subsequently exit the luminaire.

### CROSS-REFERENCE TO RELATED APPLICATIONS

This application claims the benefit under 35 U.S.C. § 119(e) of the earlier filing date of U.S. Provisional Patent Application No. 62/332,365 filed on May 5, 2016, the contents of which are hereby incorporated by reference in their entirety.

### INTRODUCTION

This application discloses an invention which is related, generally and in various aspects, to a light emitting diode replacement for a fluorescent lamp.

Light emitting diode (LED) technology is an energy efficient, highly reliable technology that is finding considerable utility in replacing fluorescent lamps in many lighting applications. An issue with LEDs that limits their utility is that they are point sources as opposed to continuous sources of light. This creates unacceptable glare or poor aesthetics in many lighting applications. What is needed is an efficient means of converting the point source illumination from LEDs into a light output distribution similar to that of fluorescent lamps. That is to say, an LED based luminaire is needed that has an even distribution of luminance across its luminous surface and whose form factor is similar to that of fluorescent lamps.

### BRIEF DESCRIPTION OF THE DRAWINGS

The novel features of the aspects described herein are set forth with particularity in the appended claims. The aspects, however, both as to organization and methods of operation may be better understood by reference to the following description, taken in conjunction with the accompanying drawings.

FIGS. 1A-1C illustrate various aspects of a luminaire;

FIG. 2 illustrates various aspects of another luminaire;

FIG. 3 illustrates various aspects of yet another luminaire;

FIG. 4 illustrates various aspects of yet another luminaire;

FIG. 5 illustrates various aspects of yet another luminaire;

FIG. 6 illustrates various aspects of yet another luminaire;

FIG. 7 illustrates various aspects of yet another luminaire;

FIG. 8 illustrates various aspects of yet another luminaire;

FIG. 9 illustrates various aspects of yet another luminaire;

FIG. 10 illustrates various aspects of yet another luminaire;

FIGS. 11A-11B illustrate various aspects of yet another luminaire;

FIG. 12 illustrates various aspects of yet another luminaire;

FIG. 13 illustrates various aspects of yet another luminaire;

FIG. 14 illustrates various aspects of yet another luminaire;

FIG. 15 illustrates various aspects of yet another luminaire;

FIG. 16 illustrates various aspects of yet another luminaire;

FIG. 17 illustrates various aspects of yet another luminaire;

FIG. 18 illustrates various aspects of yet another luminaire;

FIG. 19 illustrates various aspects of yet another luminaire;

FIG. 20 illustrates various aspects of yet another luminaire;

FIGS. 21A-21B illustrate various aspects of yet another luminaire;

FIG. 22 illustrates various aspects of yet another luminaire; and

FIGS. 23A-23B illustrate various aspects of yet another luminaire.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein.

In the following detailed description, reference is made to the accompanying drawings, which form a part hereof. In the drawings, similar symbols and reference characters typically identify similar components throughout several views, unless context dictates otherwise. The illustrative aspects described in the detailed description, drawings and claims are not meant to be limiting. Other aspects may be utilized, and other changes may be made, without departing from the scope of the technology described herein.

The following description of certain examples of the technology should not be used to limit its scope. Other examples, features, aspects, embodiments and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, aspects, embodiments, examples, etc. described herein may be combined with any one or more of the other teachings, expressions, aspects, embodiments, examples, etc. that are described herein. The following described teachings, expressions, aspects, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Before explaining the various aspects of the luminaire in detail, it should be noted that the various aspects disclosed herein are not limited in their application or use to the details of construction and arrangement of parts illustrated in the accompanying drawings and description. Rather, the disclosed aspects may be positioned or incorporated in other aspects, variations and modifications thereof, and may be practiced or carried out in various ways. Accordingly, aspects of the luminaire disclosed herein are illustrative in nature and are not meant to limit the scope or application thereof. Furthermore, unless otherwise indicated, the terms and expressions employed herein have been chosen for the purpose of describing the aspects for the convenience of the reader and are not meant to limit the scope thereof. In addition, it should be understood that any one or more of the disclosed aspects, expressions of aspects, and/or examples thereof, can be combined with any one or more of the other disclosed aspects, expressions of aspects, and/or examples thereof, without limitation.

Also, in the following description, it is to be understood that terms such as vertical, horizontal, top, bottom, above, upward, up, down, length, width, height and the like are words of convenience and are not to be construed as limiting terms. Terminology used herein is not meant to be limiting insofar as devices described herein, or portions thereof, may be attached or utilized in other orientations. The various aspects will be described in more detail with reference to the drawings.

As described in more detail hereinbelow, the luminaires disclosed herein utilize a series of reflective surfaces arranged in the path of light emanating from a line of a plurality of discrete sources of light (e.g., light emitting diodes) such that the resultant light emission resembles that of a fluorescent tube lamp. Light from a line of LEDs is emitted into a cavity overlaying the LEDs or light from two lines of LEDs is emitted into two such cavities. The cavities are filled with air or another transparent material. A sequence of reflective surfaces adjoin each cavity and are situated such that the first reflective surface in the sequence both reflects and alters the angular distribution of the light rays traveling through the cavity from the LEDs to this first reflective surface. The light reflected from the first reflective surface encounters a further series of reflective surfaces each of which further alters the angular distribution of the light propagation and with each successive reflective surface relaying the light onward to the next reflective surface in the sequence. After encountering the last reflective surface in the sequence, the spatial distribution of the light has been altered such that it is nearly or completely uniform. Thus, the luminaires disclosed herein which include the assembly of LEDs, cavities, and reflective surfaces function to convert the light output distribution of the LEDs into a distribution that resembles that of a fluorescent lamp.

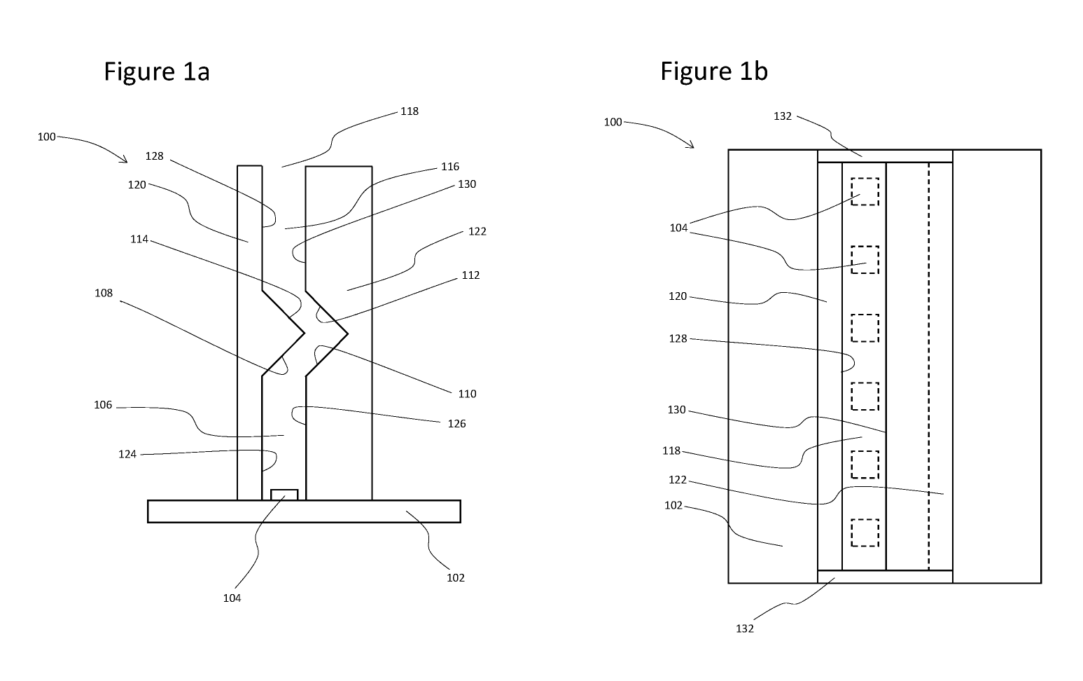

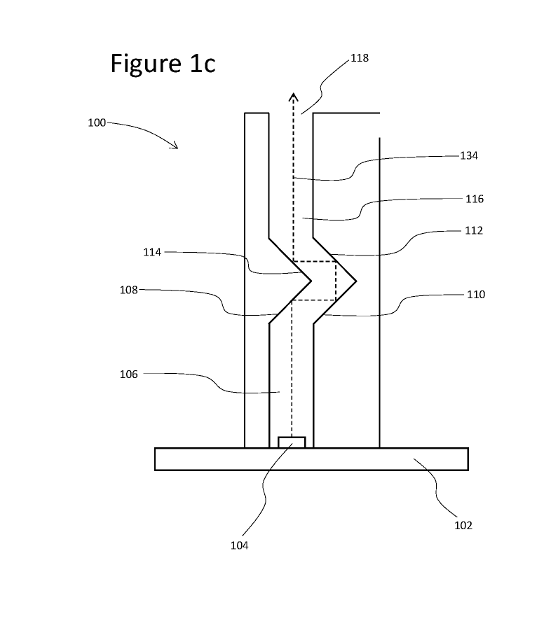

FIGS. 1A, 1B and 1C illustrate various aspects of a luminaire 100. FIG. 1A is a cross-sectional view of the luminaire 100. FIG. 1B is a plan view of the luminaire 100 and FIG. 1C portrays the average path that a ray of light 134 follows on exiting the LEDs 104. The luminaire 100 includes a substrate 102, a line of discrete sources of light 104 (e.g., LEDs), a cavity 106 formed by planar reflective surfaces 124, 126 (and optionally by reflective end panels 132), a cavity formed by planar reflective surfaces 108, 110, 112, 114 and a cavity 116 formed by planar reflective surfaces 128, 130 (and optionally by reflective end panels 132). Reflective surfaces 124, 108, 114, 128 are formed on a slab of material 120. Reflective surfaces 126, 110, 112, 130 are formed on a slab of material 122. The cavities extend along the length of the luminaire 100 and may be considered to be a single cavity or multiple cavities. It will be appreciated that the cross-sections of the cavities shown in FIG. 1 are uniform along their respective lengths.

The substrate 102 may include any suitable material. According to various aspects the substrate 102 is a printed circuit board. As shown in FIG. 1B, the substrate 102 extends the length of the luminaire 100. The discrete sources of light 104 are positioned on the substrate 102 along a length of the luminaire and may be any suitable type of discrete sources of light 104. For example, according to various aspects, the discrete sources of light 104 may be any suitable type of light emitting diodes. For purposes of simplicity, for the luminaire 100 and the other luminaires described hereinafter, the discrete sources of light will hereinafter be described in the context of light emitting diodes. However, it will be appreciated that the discrete sources of light may be other than light emitting diodes. Light emitting diodes (LEDs) 104 may be chosen to emit any suitable wavelength or wavelength band of light. According to various aspects LEDs 104 emit white light. The LEDs 104 are attached to the substrate 102. Any suitable method of attachment may be utilized to attach the LEDs 104 to the substrate 102 as is well-known in the art. For instance, LEDs 104 may be wave soldered to a circuit board 102.

Slabs of material 120, 122 may include any suitable material. According to various aspects, slabs 120, 122 may be formed from plastic material, for instance, by extrusion, injection molding, or casting. According to other aspects, slabs 120, 122 may be formed from sheet metal by a stamping or bending process. The slab 120 may be considered a first body member, the slab 122 may be considered a second body member, and the cavity may be considered as being positioned between or defined by the first and second body members. It will be appreciated that the cross-section of the slab/first body member 120 shown in FIG. 1A, including the portion adjacent the cavity, is uniform along the length of the cavity and the cross-section of the slab/second body member 122 shown in FIG. 1A, including the portion adjacent the cavity, is uniform along the length of the cavity. As shown in FIG. 1A, the slab/first body member 120 includes/defines a protrusion which extends along the length of the cavity and includes the surfaces 108, 114, and the slab/second body member 122 includes/defines a recess which extends along the length of the cavity, is opposite the protrusion and includes the surfaces 110, 112. The surface 108 may be considered a first light reflective surface of the protrusion of the slab/first body member 120 and the surface 110 may be considered a second light reflective surface of the recess of the slab/second body member 122.

According to various aspects, surfaces 124, 126, 108, 110, 112, 114, 128, 130 may be specularly reflective, diffusely reflective, or a combination of the two, so long as at least one of surfaces 108, 110, 112, 114 is at least in part diffusely reflective. In some aspects, all of surfaces 108, 110, 112, 114 are diffusely reflective and in other aspects all of surfaces 124, 126, 108, 110, 112, 114, 128, 130 are diffusely reflective. According to various aspects end panels 132, if they are present, may be diffusely reflective, specularly reflective, or a combination of the two. In various aspects, cavities 106, 116 as well as the spaces between reflective surfaces 108, 110 and between reflective surfaces 112, 114 are filled with air. These cavities and spaces may be filled, in other aspects, with some other transparent material.

The reflective surfaces 124, 126, 108, 110, 112, 114, 128, 130 may be formed from any suitable material or by any suitable process. For example, according to various aspects, slabs 120 and/or 122 may be formed from intrinsically reflective material such as plastic material that is loaded with a reflective pigment thus yielding the desired reflective surfaces. Alternatively, according to various aspects, the slabs 120 and/or 122 may be formed from a reflective metal. According to other aspects, the reflective surfaces 124, 126, 108, 110, 112, 114, 128 and/or 130 may be formed by coating reflective material onto the surfaces of slabs 120 and/or 122 by processes such as painting, spray coating, pad printing, or vacuum deposition. According to other aspects, reflective surfaces 124, 126, 108, 110, 112, 114, 128 and/or 130 may be formed by adhering a reflective adhesive-backed film to the material from which slabs 120 and/or 122 are formed. Any suitable adhesive may be utilized to adhere the reflective film to the slabs 120 and/or 122.

In operation LEDs 104 emit light into cavity 106. The cavity 106 is positioned to receive all light emitted by the LEDs 104. On average the light emitted by LEDs 104 travels upward (as portrayed by light ray 134 shown in FIG. 1C) until it impinges on reflective surface 108. The term “on average” is used here because LEDs emit light over a range of angles and also because, to the extent that surfaces 124, 126, 108, 110, 112, 114, 128, 130 are diffuse reflectors, they reflect light over a range of angles. Thus the direction of light propagation in cavity 106 is generally, but not uniformly, upward. In FIG. 1C, light ray 134 is drawn to show the “average” direction of the light propagation of a light ray as it transits through the luminaire 100. To the extent that the various reflective surfaces in the luminaire 100 are diffuse the angular distribution of light propagation through the luminaire 100 will diverge to a greater or lesser extent from this average direction.

Reflective surface 108 is so situated that all light traveling vertically upward in cavity 106 impinges on surface 108. Reflective surface 108 is also oriented such that light reflected from it is on average directed (from left to right in FIG. 1A) towards reflective surface 110 as is portrayed by light ray 134 in FIG. 1C. Reflective surface 110 is so situated that all light that is reflected from surface 108 and that is traveling from left to right in FIG. 1A impinges on surface 110. In other words, all light emitted by the LEDs 104 in the direction normal to the substrate 102 (“upwards” relative to FIG. 1C) first strikes the surface 108, is then reflected from the surface 108 before encountering any other surface of the luminaire 100, and then strikes the surface 110. Reflective surface 110 is also oriented such that light reflected from it is on average directed (upward in FIG. 1A) towards reflective surface 112 as is portrayed by light ray 134 in FIG. 1C. Reflective surface 112 is so situated that all light that is reflected from surface 110 and that is traveling upward in FIG. 1A impinges on surface 112. Reflective surface 112 is also oriented such that light reflected from it is on average directed (from right to left in FIG. 1A) towards reflective surface 114 as is portrayed by light ray 134 in FIG. 1C. Reflective surface 114 is so situated that all light that is reflected from surface 112 and that is traveling from right to left in FIG. 1A impinges on surface 114. Reflective surface 114 is also oriented such that light reflected from it is on average directed (upward in FIG. 1A) through cavity 116. The light reflected from surface 114 that travels upward through cavity 116 exits the luminaire 100 through aperture 118. The aperture 118 extends along the length of the cavity opposite the substrate 102, and is positioned to allow light reflected from the surface 110 to subsequently exit the luminaire (after the light reflected from the surface 110 is subsequently reflected from the surface 112 and the surface 114).

As was described above, light is emitted from the LEDs 104 and is reflected from diffuse reflectors over a range of angles. This means that some light emitted by LEDs 104 will have an angular component in the vertically up or down direction in FIG. 1B. This also means that light striking reflective surfaces 108, 110, 112, 114 will, to the extent that these are diffuse reflectors, have on average an increased angular component in the vertically up or down direction in FIG. 1B after reflection. The result is that the area in a plane parallel to that of FIG. 1B in which light from a particular LED 104 is found increases considerably after each reflection from a diffuse surface such as surfaces 108, 110, 112, 114. After the light from LEDs 104 has transited surfaces 108, 110, 112, 114 suffering diffuse reflections, the areas occupied by light from each of the LEDs overlap to such an extent that the light exiting aperture 118 is spatially uniform across the aperture. Thus an individual viewing the luminaire 100 from above in as portrayed in FIG. 1A will observe a continuous light source emanating from the light exiting aperture 118.

For these aspects, it should be noted that an observer looking down into the luminaire 100 from above as portrayed in FIG. 1A does not have a direct line of sight to LEDs 104. Surfaces 108 and 114 occlude direct viewing of the LEDs 104.

In order for reflective surfaces 108, 110, 112, 114 of the luminaire 100 to function as described, all these reflective surfaces should be oriented at an angle of 45° from the vertical as portrayed in FIG. 1A. According to other aspects, the reflective surfaces 108, 110, 112, 114 in FIG. 1 (or their equivalent in other aspects) may have curved rather than planar surfaces or surfaces that combine curved and planar areas.

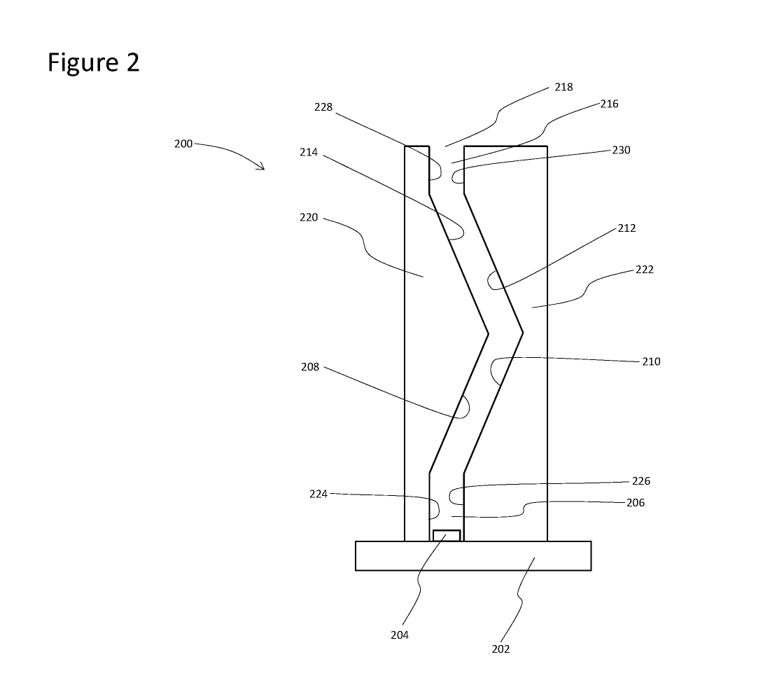

FIG. 2 illustrates various aspects of a luminaire 200 having reflective surfaces oriented at an angle other than 45° from the vertical. The luminaire 200 is similar to the luminaire 100 but is different. For the aspects shown in FIG. 2, the reflective surfaces 208, 210, 212, 214 are oriented at an angle of 22.5° from the vertical. Angles smaller than 22.5° may increase the height of the luminaire 200 to the point where the height is unacceptably tall. If surfaces 108, 110, 112 are oriented at angles greater than 45° from the vertical as portrayed in FIG. 1, light becomes trapped in the device for an unacceptable number of reflections degrading light output efficiency.

When the luminaire 200 is in operation, LEDs 204 emit light into cavity 206. On average the light emitted by LEDs 204 travels upward (as shown in FIG. 2) until it impinges on reflective surface 208. Reflective surface 208 is oriented at an angle between 22.5° and 45° to the vertical and is so situated that all light traveling vertically upward in cavity 206 impinges on surface 208. Reflective surface 210 is oriented at an angle of between 22.5° and 45° to the vertical and is so situated that were reflective surface 208 specularly reflective, all light travelling vertically upward in cavity 206 would be reflected onto surface 210. Reflective surface 212 is in turn oriented at an angle of between −22.5° and −45° to the vertical and is so situated that were both reflective surfaces 208 and 210 specularly reflective, all light travelling vertically upward in cavity 206 would be reflected onto surface 212. Reflective surface 214 is so situated that were reflective surfaces 208, 210, 212 all specularly reflective, all light travelling vertically upward in cavity 206 would be reflected onto surface 214.

Reference to surfaces 208, 210, 212 being specularly reflective in the above paragraph are only meant define their relative position and orientation in space. For the proper operation of the luminaire 200 one or more of these surfaces is at least in part diffusely reflecting in nature.

The constraints on the angular orientation of reflective surface 214 are relaxed as compared to reflective surfaces 208, 210, 212. Reflective surface 214 may be oriented at an angle greater than −90° and less than or equal to −22.5° to the vertical as portrayed in FIG. 2. Reflective surface 214 is oriented such that light reflected from it is on average directed (upward in FIG. 2) through cavity 216. The light reflected from surface 214 that travels upward through cavity 216 exits the luminaire 100 through aperture 218.

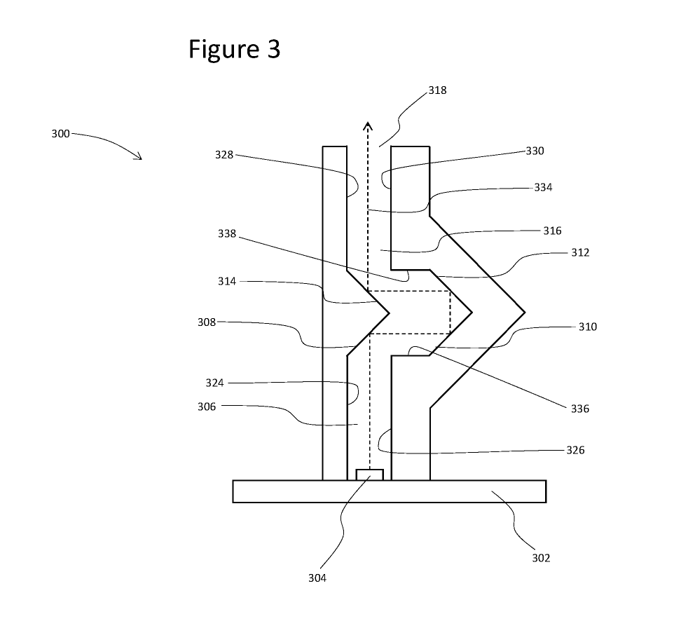

FIG. 3 illustrates various aspects of a luminaire 300. The luminaire 300 is similar to the luminaire 100 but is different. In contrast to the luminaire 100, where the reflective surface 110 immediately adjoins wall 126 of cavity 106, the luminaire 300 includes an intermediate surface 336 that connects reflective surface 310 to cavity wall 326. There is also an intermediate surface 338 that connects wall 330 of cavity 316 to reflective surface 312. Surfaces 336, 338 are reflective surfaces. The inclusion of these two additional surfaces in the luminaire 300 has the result that the distances from reflective surface 308 to reflective surface 310 and from reflective surface 312 to reflective surface 314 are greater than they would otherwise be. This has the result that the path length of light through the luminaire 300 is greater than it would otherwise be. This can have the advantage of allowing greater spatial uniformity in the intensity of light emerging from aperture 318.

Intermediate reflective surfaces may also be inserted connecting reflective surfaces 308, 314 and also connecting reflective surfaces 310, 312.

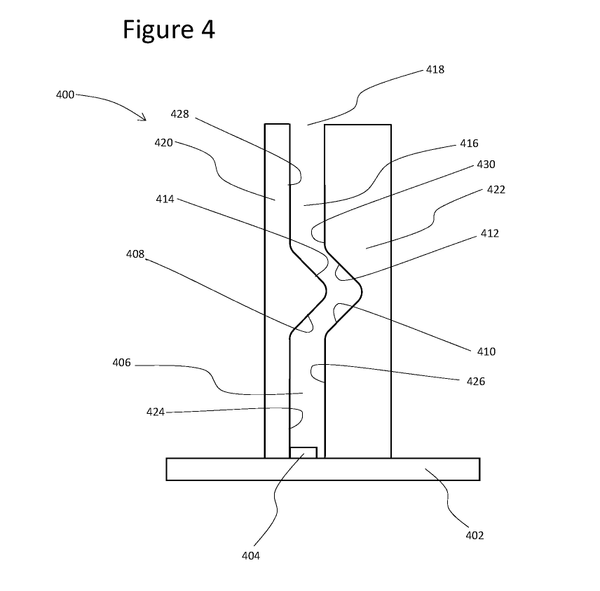

FIG. 4 illustrates various aspects of a luminaire 400 having curved rather than planar surfaces or surfaces that combine curved and planar areas. Reflective surface 408 has a curved section that connects it to cavity wall 424. There is also a curved intermediate surface that connects reflective surface 408 to reflective surface to reflective surface 414. Since light travelling vertically up through cavity 406 does not strike the curved surface between surfaces 408, 414, this curved surface is not part of surface 408. Similarly, reflective surface 410 has a curved section that connects it to cavity wall 426 and there also is a curved intermediate surface that connects reflective surface 410 to reflective surface to reflective surface 412. As was the case with the luminaire 200, reflective surface 410 is the reflective surface that would be illuminated by light that travels vertically up through cavity 406 and then is specularly reflected by reflective surface 408. There are curved intermediate surfaces between reflective surfaces 412, 414 and cavity walls 428, 430.

Reflective surfaces 408, 410 may be curved so long as lines tangent to these surfaces and in the plane of FIG. 4 have angles with the vertical that lie between 0° and 45° to the vertical in FIG. 4. Reflective surface 412 may be curved so long as lines tangent to this surface and in the plane of FIG. 4 have angles with the vertical that lie between 0° and −45° to the vertical in FIG. 4. Reflective surface 414 may be curved so long as lines tangent to this surface and in the plane of FIG. 4 are oriented at an angle greater than −90° and less than or equal to 0° to the vertical as portrayed in FIG. 4.

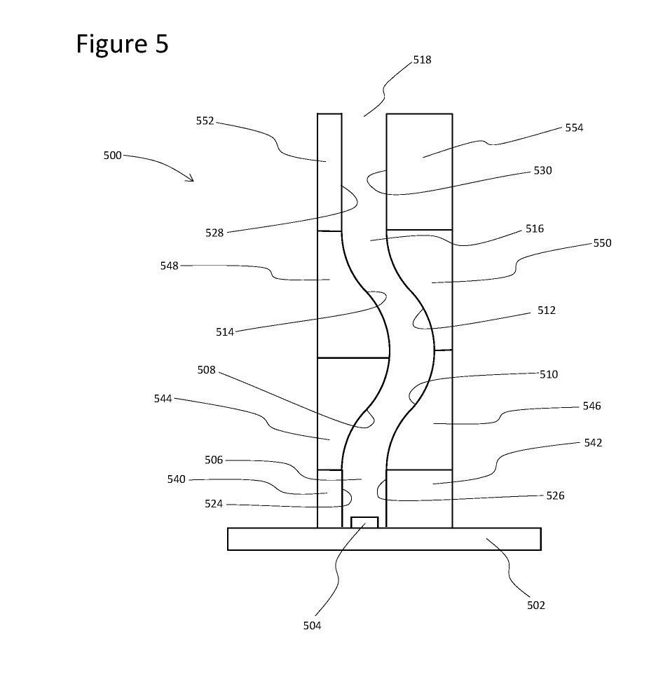

FIG. 5 illustrates various aspects of a luminaire 500. In these aspects, reflective surfaces 524, 508, 514, 528 are formed on material slabs 540, 544, 548, 552 respectively. Reflective surfaces 526, 510, 512, 530 are formed on material slabs 542, 546, 550, 554 respectively. Reflective surfaces 508, 510, 512, 514, which are similar to reflective surfaces 108, 110, 112, 114 in FIG. 1, are curved with no planar portions. Walls 524, 526 of cavity 506 are tangent to the curved reflective surfaces 508, 510 respectively. All light that is propagating vertically in cavity 506 illuminates surface 508. All lines that are tangent to surfaces 508, 510 and are in the plane of FIG. 5 have angles with the vertical in FIG. 5 of between 0° and 45°. Reflective surface 512 may act as a continuation of curved surface 510, may be a curved surface tangent to the curved surface 510, or may be connected to curved surface 510 by an intermediate reflective surface that is either planar or curved. This intermediate surface may have any shape so long as it would not interfere with the passage of light that had been propagating vertically in cavity 506 and had been specularly reflected from surfaces 508, 510. Reflective surface 512 has a curvature such that all lines tangent to its surface and in the plane of FIG. 5 have angles with the vertical in FIG. 5 of between 0° and −45°. Reflective surfaces 510 and 512 are so situated that were reflective surface 508 specularly reflective, all light travelling vertically upward in cavity 506 would be reflected onto either surface 510 or surface 512. (In this aspect some portion of light traveling vertically in cavity 506 would be specularly reflected twice from surface 508 before impinging on either reflective surface 510 or reflective surface 512.) Reflective surface 514 may act as a continuation of curved surface 508, may be a curved surface tangent to the curved surface 508, or may be connected to curved surface 508 by an intermediate reflective surface that is either planar or curved. This intermediate surface may have any shape so long as it would not interfere with the passage of light that had been propagating vertically in cavity 506 and had been specularly reflected from surfaces 508, 510. Reflective surface 514 has a curvature such that all lines tangent to its surface and in the plane of FIG. 5 have angles with the vertical in FIG. 5 less than or equal to 0° and greater than −90°. Reflective surface 514 and surface 528 of cavity 516 are so situated that were reflective surfaces 508, 510, 512 specularly reflective, all light travelling vertically upward in cavity 506 would be reflected onto either surface 514 or surface 528. Reflective surface 514 is oriented such that light reflected from it is on average directed (upward in FIG. 5) through cavity 516. Surfaces 528, 530 are tangent to surfaces 514, 512 respectively. The light reflected from surface 514 that travels upward through cavity 516 exits the luminaire 500 through aperture 518.

References to surfaces 508, 510, 512 being specularly reflective in the above paragraph are only meant define their relative position and orientation in space. For the proper operation of the luminaire 500 one or more of these surfaces is at least in part diffusely reflecting in nature.

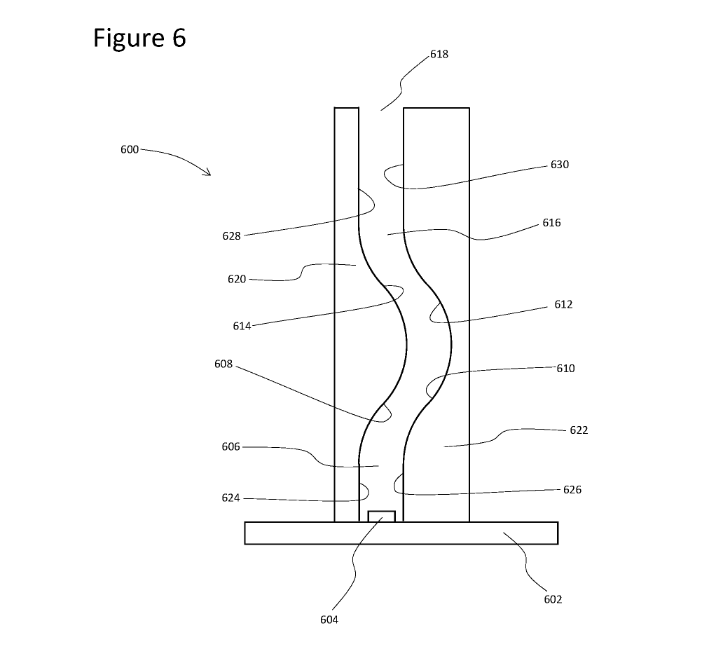

FIG. 6 illustrates various aspects of a luminaire 600. The functionality of the luminaire 600 is similar to that of the luminaire 500, but the luminaire 600 is simpler to fabricate. In these aspects, slabs 540, 544, 548, 552 are combined to together to form a single continuous slab of material 620. Slabs 542, 546, 550, 554 are combined together to form a continuous slab of material 622. All light that is propagating vertically in cavity 606 illuminates surface 608. All lines that are tangent to surfaces 608, 610 and are in the plane of FIG. 6 have angles with the vertical in FIG. 6 of between 0 and 45°. Reflective surface 612 may act as a continuation of and be directly adjacent to curved surface 610, may be a curved surface tangent to the curved surface 610, or may be connected to curved surface 610 by an intermediate reflective surface that is either planar or curved and that is also formed on the surface of slab 622. This intermediate surface may have any shape so long as it would not interfere with the passage of light that had been propagating vertically in cavity 606 and had been specularly reflected from surfaces 608, 610. Reflective surface 612 has a curvature such that all lines tangent to its surface and in the plane of FIG. 6 have angles with the vertical in FIG. 6 of between 0° and −45°. Reflective surfaces 610, 612 are so situated that were reflective surface 608 specularly reflective, all light travelling vertically upward in cavity 606 would be reflected onto either surface 610 or surface 612 or any intermediate surface optionally connecting them. (In these aspects some portion of light traveling vertically in cavity 606 would be specularly reflected twice from surface 608 before impinging on either reflective surface 610 or reflective surface 612.)

Reflective surface 614 may act as a continuation of and be directly adjacent to curved surface 608, may be a curved surface tangent to the curved surface 608, or may be connected to curved surface 608 by an intermediate reflective surface that is either planar or curved and that is also formed on the surface of slab 620. This intermediate surface may have any shape so long as it would not interfere with the passage of light that had been propagating vertically in cavity 606 and had been specularly reflected from surfaces 608 and 610. Reflective surface 614 has a curvature such that all lines tangent to its surface and in the plane of FIG. 6 have angles with the vertical in FIG. 6 less than or equal to 0° and greater than −45°. Reflective surface 614 and surface 628 of cavity 616 are so situated that were reflective surfaces 608, 610, 612 specularly reflective, all light travelling vertically upward in cavity 606 would be eventually reflected onto either surface 614 or surface 628. Reflective surface 614 is oriented such that light reflected from it is on average directed (upward in FIG. 6) through cavity 616 formed by surfaces 628, 630. Surfaces 628, 630 are tangent to surfaces 614, 612 respectively. The light reflected from surface 614 that travels upward through cavity 616 exits the luminaire 600 through aperture 618.

References to surfaces 608, 610, 612 being specularly reflective are only meant define their relative position and orientation in space. For the proper operation of the luminaire 600 one or more of these surfaces is at least in part diffusely reflecting in nature.

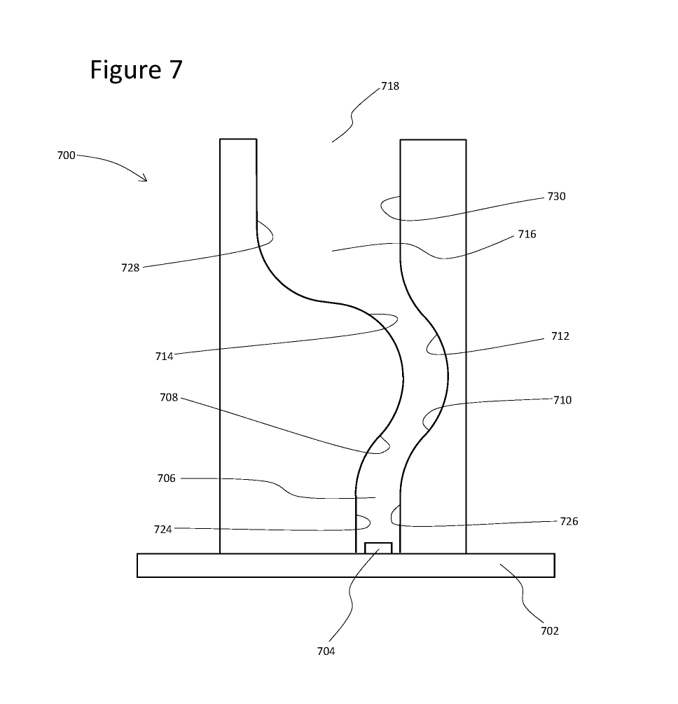

FIG. 7 illustrates various aspects of a luminaire 700. The luminaire 700 is similar to the luminaire 600 but is different. In contrast to the luminaire 600, where the reflective surface 614 has a curvature such that all lines tangent to its surface and in the plane of FIG. 6 have angles with the vertical in FIG. 6 that are not greatly less than −22.5°, the reflective surface 714 of the luminaire 700 has a curvature such that some lines tangent to its surface and in the plane of FIG. 7 have angles with the vertical that approach −90°. The result is that cavity 716 of the luminaire 700 is much wider than cavity 616 of the luminaire 600.

All the aspects of the luminaires described hereinabove have had cavity walls of the type represented by 124, 126, 128, 130 in FIG. 1 that are planar and perpendicular to the substrates represented by 102 in FIG. 1. However, these cavity walls need not be planar or normal to the substrate.

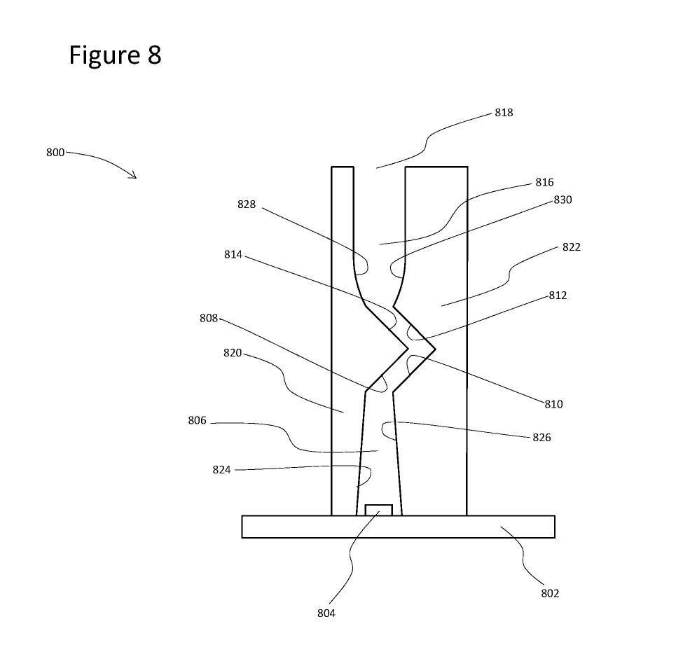

FIG. 8 illustrates various aspects of a luminaire 800 having reflective cavity walls 824, 826 which are planar but are not oriented perpendicular to substrate 802. Additionally, reflective cavity walls 828, 830 are not planar but rather are curved. Reflective surfaces 808, 810, 812, 814 are similar to surfaces 108, 110, 112, 114 in FIG. 1.

In some aspects of the luminaires, cavities of the type illustrated by cavities 106, 116 in FIG. 1 may be truncated or eliminated from the luminaire assemblies.

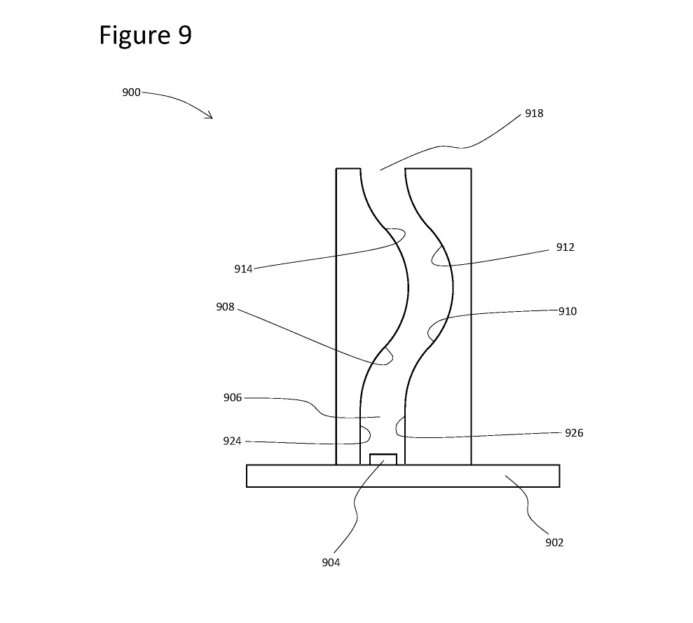

FIG. 9 illustrates various aspects of a luminaire 900. The luminaire 900 is similar to the luminaire 600 but is different in that the luminaire 900 does not include a cavity equivalent to cavity 616 in the luminaire 600. Rather, for the luminaire 900, the aperture 918 lies at the ends of reflective surfaces 912, 914.

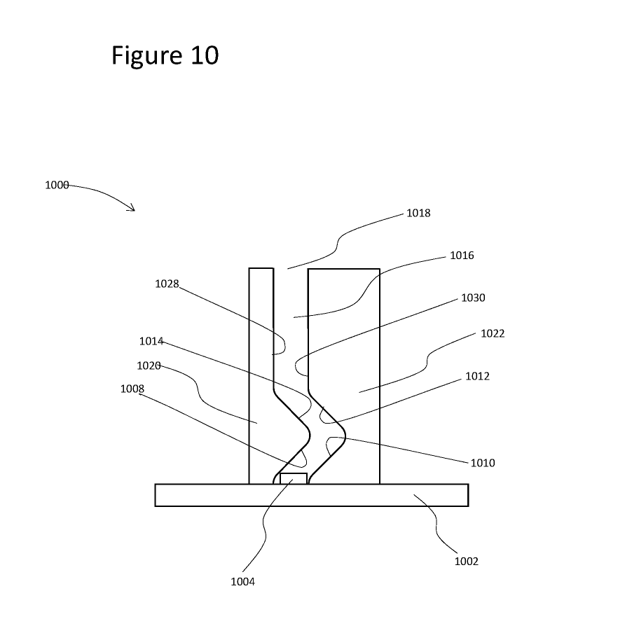

FIG. 10 illustrates various aspects of a luminaire 1000. The luminaire 1000 is similar to the luminaire 400 but is different in that the luminaire 1000 does not include a cavity equivalent to cavity 406 in FIG. 4. Rather, for the luminaire 1000, the reflective surfaces 1024, 1026 end at the surface of substrate 1002.

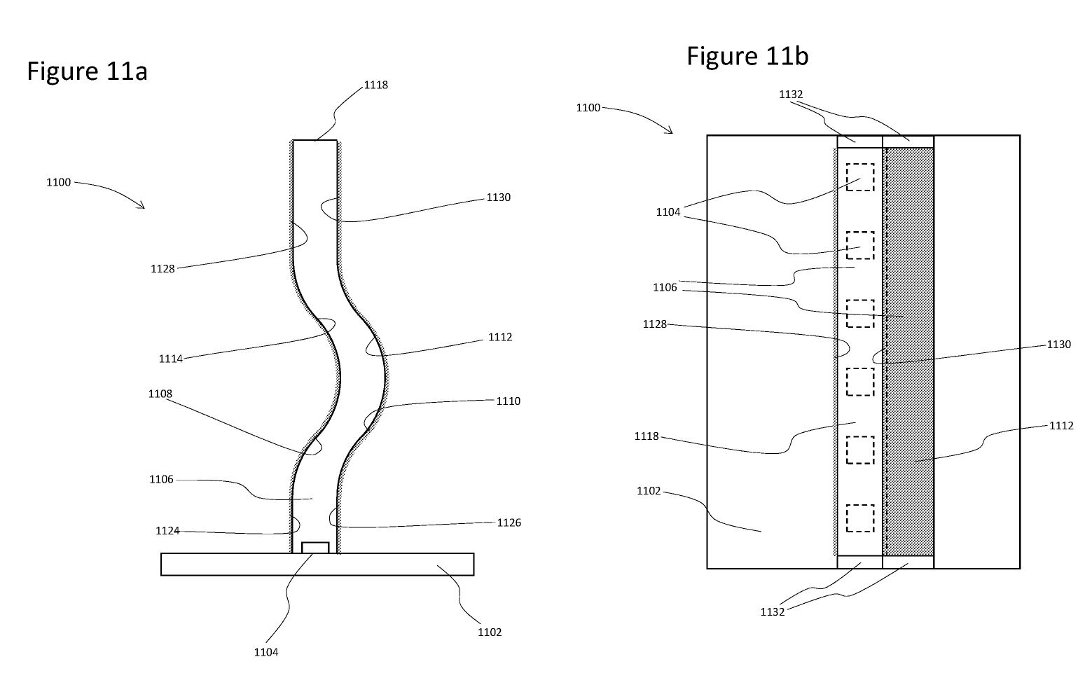

For the luminaires described hereinabove (e.g., luminaires 100-1000), the medium through which light propagates within the luminaire is most usually air. The reflective surfaces, for instance 124, 126, 108, 110, 112, 114, 128 and 130 in FIG. 1, are formed on solid slabs that surround the light propagating medium. FIGS. 11A-11B illustrate various aspects of a luminaire 1100 where light propagates through a transparent solid medium within the luminaire 1100. FIG. 11A illustrates a cross-section and FIG. 11B illustrates a plan view of the luminaire 1100. Required reflective surfaces are formed on outside surfaces of that transparent medium. The transparent light propagating medium may be any suitable transparent solid material. Examples of suitable materials are plastics and glass.

For the luminaire 1100, light is emitted from a line of LEDs 1104 situated on substrate 1102. The light enters cavity 1106 formed from a transparent material. Two surfaces 1124, 1126 of cavity 1106 have light reflective films coated or adhered onto them. A surface 1108 of the transparent light propagating medium is situated such that all light propagating vertically (as shown in FIG. 11a) in cavity 1106 is incident on surface 1108. Cavity wall 1124 is tangent to curved surface 1108 and all lines tangent to surface 1108, and that are in the plane of FIG. 11a have angles with the vertical in FIG. 11 of between 0° and 45°. Surface 1108 has a light reflective film coated or adhered onto it. A second curved surface 1110 of the transparent light propagating medium is situated such that cavity wall 1126 is tangent to it and such that all lines tangent to surface 1110, and that are in the plane of FIG. 11a have angles with the vertical in FIG. 11 of between 0° and 45°. Surface 1110 has a light reflective film coated or adhered onto it. Surface 1112 of the light propagating medium may act as a continuation of curved surface 1110, may be a curved surface tangent to the curved surface 1110, or may be connected to curved surface 1110 by an intermediate surface that is either planar or curved. This intermediate surface may have any shape so long as it would not interfere with the passage of light that had been propagating vertically in cavity 1106 and had been specularly reflected from surfaces 1108, 1110.

Surface 1112 has a curvature such that all lines tangent to its surface and in the plane of FIG. 11 have angles with the vertical in FIG. 11 of between 0° and −45°. Surface 1112 and any intermediate surface between it and surface 1110 have a light reflective film coated or adhered to them. Surfaces 1110, 1112 are so situated that were reflective surface 1108 specularly reflective, all light travelling vertically upward in cavity 1106 would be reflected onto either surface 1110 or surface 1112 or any intermediate surface optionally connecting them. Curved surface 1114 of the light propagating medium may act as a continuation of and be directly adjacent to curved surface 1108, may be a curved surface tangent to the curved surface 1108, or may be connected to curved surface 1108 by an intermediate surface that is either planar or curved and that is also a portion of the surface of the light propagating medium. This intermediate surface may have any shape so long as it would not interfere with the passage of light that had been propagating vertically in cavity 1106 and had been specularly reflected from surfaces 1108, 1110.

Surface 1114 of the light propagating medium has a curvature such that all lines tangent to its surface and in the plane of FIG. 11 have angles with the vertical in FIG. 11 less than or equal to 0° and greater than −90°. Surface 1114 and surface 1128 of cavity 1116 are so situated that were surfaces 1108, 1110, 1112 all specularly reflective, all light travelling vertically upward in cavity 1106 would be eventually reflected onto either surface 1114 or surface 1128. Surface 1114 and any intermediate surface between it and surface 1108 have a light reflective film coated or adhered to them. Surface 1114 is oriented such that light reflected from it is on average directed (upward in FIG. 11) through cavity 1116 formed by surfaces 1128, 1130. Surfaces 1128, 1130 are tangent to surfaces 1114, 1112 respectively and have a light reflective film coated or adhered to them. The light reflected from surface 1114 that travels upward through cavity 1116 exits the luminaire 1100 through aperture 1118.

References to surfaces 1108, 1110, 1112 being specularly reflective in the above paragraph are only meant define their relative position and orientation in space. For the proper operation of the luminaire 1100 one or more of these surfaces is at least in part diffusely reflecting in nature. Optionally, the light propagating medium of the luminaire 1100 may have light reflecting films 1132 coated or adhered onto its end surfaces as shown in FIG. 11b. The reflective surfaces for such aspects of the luminaire 1100 have a configuration and orientation that is similar to the reflective surfaces utilized in the luminaire 600. Other reflective surface configurations as described in the preceding paragraphs may also be used in aspects that utilize a solid light propagation medium.

Thus far all the aspects of the luminaires described hereinabove have utilized four light reflecting surfaces, for instance surfaces 108, 110, 112, 114 in FIG. 1, that are most usually situated between two light transmitting cavities, for instance cavities 106, 116 in FIG. 1. In some aspects of the luminaires, a greater or lesser number of reflecting surfaces may be utilized.

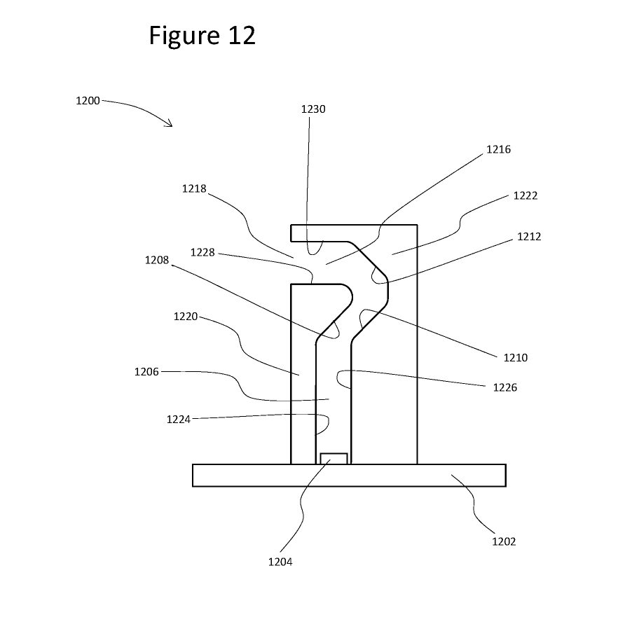

FIG. 12 illustrates various aspects of a luminaire 1200 which utilizes an odd number of reflective surfaces. As shown in FIG. 12, the luminaire 1200 includes three reflective surfaces 1208, 1210, 1212 that are situated between two cavities 1206, 1216 that have reflective cavity walls 1224, 1226, 1228, 1230. Aspects of luminaires like the luminaire 1200 which utilize odd numbers of reflective surfaces (e.g. three or five) are well suited for applications where the direction of light exiting the luminaire is desired to be perpendicular to the average direction of light exiting the LEDs. These luminaires may be particularly useful in wall wash and down lighting applications. The luminaire 1200 utilizes reflective surfaces that combine curved and planar areas in a manner similar to the reflective surfaces of the luminaire 400. Reflective surfaces 1208, 1210, 1212 all function in a manner similar to surfaces 408, 410, 412 of the luminaire 400. Light reflected from surface 1212 is directed into cavity 1216 and then out through aperture 1218.

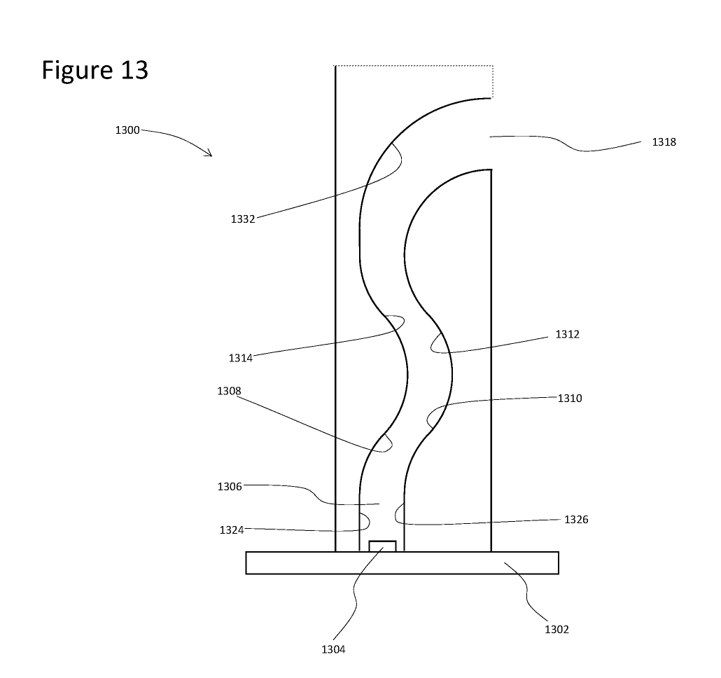

FIG. 13 illustrates various aspects of a luminaire 1300 which utilizes five light reflecting surfaces, 1308, 1310, 1312, 1314, 1332. Cavity 1306 with reflective cavity walls 1324, 1326 and reflective surfaces 1308, 1310, 1312, 1314 function similarly to cavity 606 with reflective walls 624, 626 and reflective surfaces 608, 610, 612, 614 of the luminaire 600. However, whereas the reflective surface 614 of the luminaire 600 reflects light into the cavity 616, the reflective surface 1314 of the luminaire 1300 reflects light into reflective surface 1332. Reflective surface 1332 is so situated that it reflects light out through aperture 1318. In other words, there is no cavity similar to cavity 616 of the luminaire 600 that lies between reflective surface 1332 and aperture 1318. At least one of reflective surfaces 1308, 1310, 1312, 1314, 1332 is at least partially diffusely reflective.

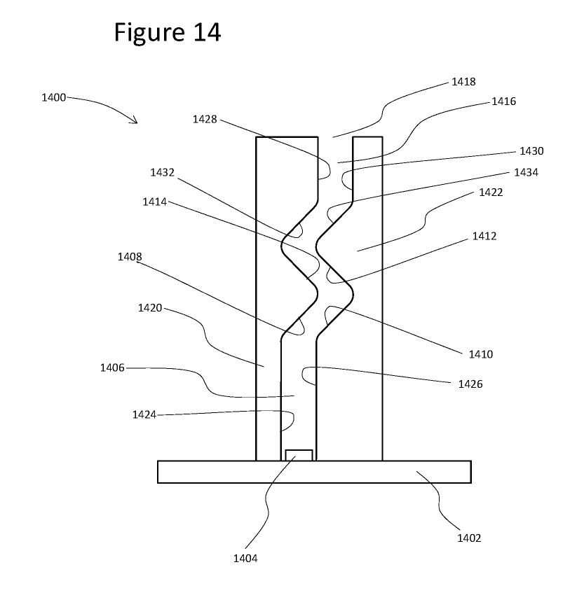

FIG. 14 illustrates various aspects of a luminaire 1400. The luminaire 1400 utilizes six reflecting surfaces 1408, 1410, 1412, 1414, 1432, 1434 situated between two cavities—cavity 1406 with reflecting walls 1424, 1426 and cavity 1416 with reflecting walls 1428, 1430. Cavities 1406, 1416 and reflecting surfaces 1408, 1410, 1412, 1414 function similar to cavities 406, 416 and reflecting surfaces 408, 410, 412, 414 of the luminaire 400. However, for the luminaire 1400, the surface 1414 relays light into reflective surface 1432 which in turn relays light into surface 1434. Surface 1434 is so situated that it directs light upward (as shown in FIG. 14) into cavity 1416. The light that traverses upward through cavity 1416 exits the luminaire 1400 through aperture 1418. At least one of reflective surfaces 1408, 1410, 1412, 1414, 1432, 1434 is at least partially diffusely reflective.

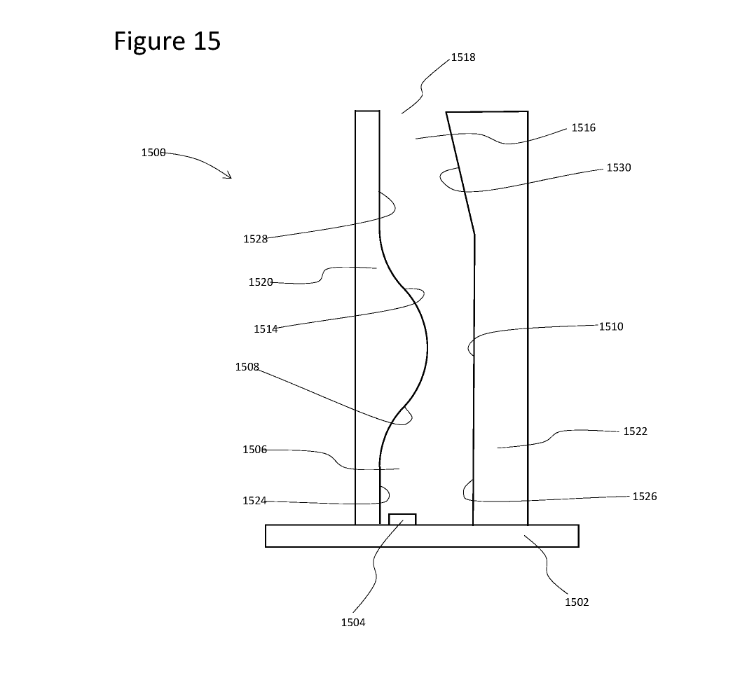

FIG. 15 illustrates various aspects of a luminaire 1500. The luminaire 1500 is similar to the luminaire 600 but is different in that reflective surfaces 610 and 612 are replaced by a single flat reflective surface 1510. If reflective surface 1510 was continued in the same plane all the way upward to aperture 1518 there would be a direct line of sight from an outside observer downward into the LEDs 1504. For this reason, reflective wall 1530 of cavity 1516 is angled away from the perpendicular such that the view downward through aperture 1518 directly to LEDs 1504 is obstructed. At least one of reflective surfaces 1508, 1510, 1514 is at least partially diffusely reflective.

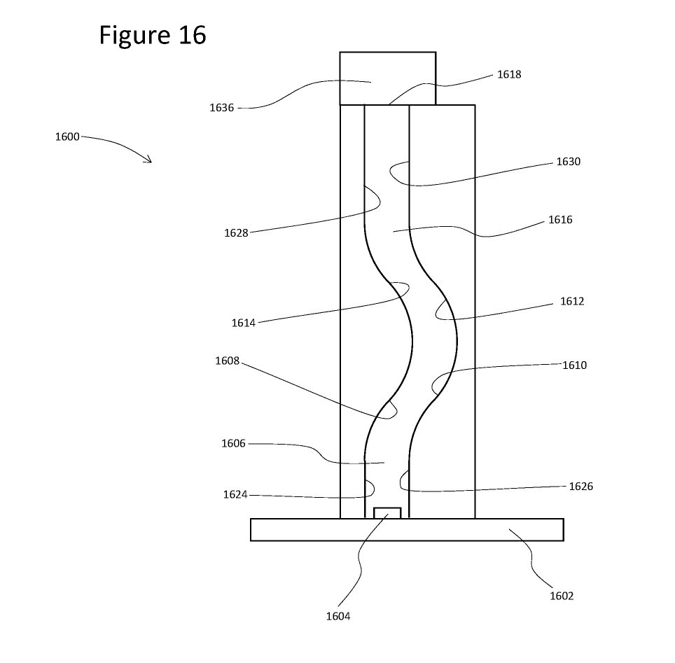

FIG. 16 illustrates various aspects of a luminaire 1600. The luminaire 1600 is similar to the luminaire 600 but is different in that the luminaire 1600 includes a light redirecting means 1636 mounted on aperture 1618. The light redirecting means 1636 may also be mounted above the aperture 1618 such that it intercepts light exiting the aperture 1618.

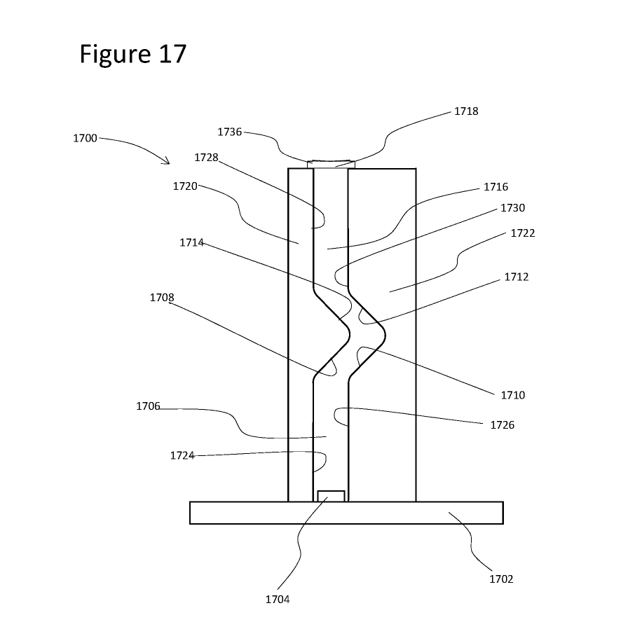

FIG. 17 illustrates various of a luminaire 1700. The luminaire 1700 is similar to the luminaire 1600 in that a light redirecting means 1736 is mounted over the aperture 1718 and is otherwise similar to the luminaire 400. According to various aspects, another difference of the luminaire 1700 from the luminaire 1600 is that the light redirecting means 1736 is specifically a negative cylindrical Fresnel lens. Other cylindrical lenses such as a positive Fresnel lens, or negative or positive conventional lenses may also be used.

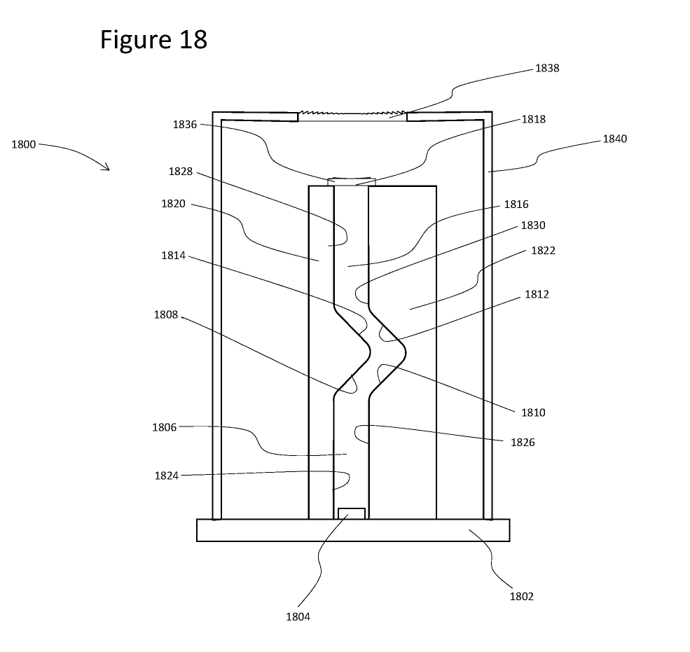

FIG. 18 illustrates various aspects of a luminaire 1800. The luminaire 1800 is similar to the luminaire 1700 except that the light redirecting means includes both a negative cylindrical Fresnel lens 1836 and a second positive cylindrical Fresnel lens 1838 that is suspended in a housing 1840 above the aperture 1818 and first cylindrical Fresnel lens 1836. Other two or more lens combinations may be used to redirect light exiting aperture 1818 into a desired distribution of illumination.

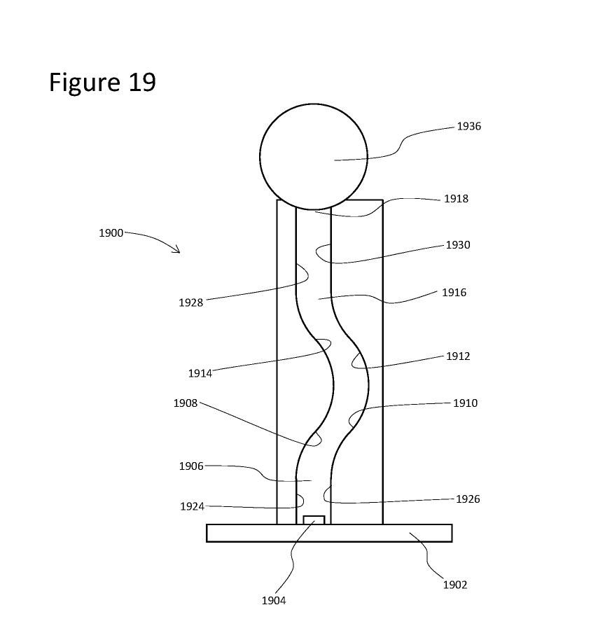

FIG. 19 illustrates various aspects of a luminaire 1900. The luminaire 1900 is similar to the luminaire 1600 but is different in that the light redirecting means 1936 mounted on aperture 1918 is specifically a cylinder of transparent material (e.g., a glass or a transparent plastic) that functions as a positive lens.

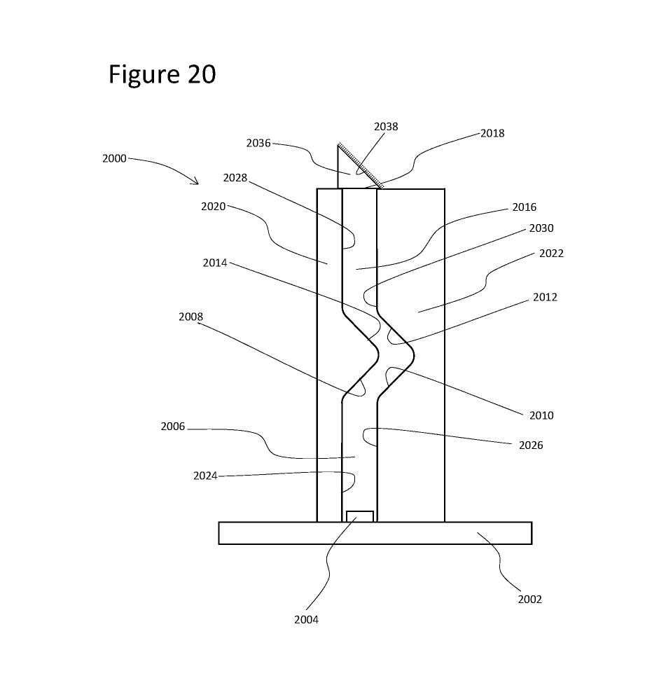

FIG. 20 illustrates various aspects of a luminaire 2000. The luminaire 2000 is similar to the luminaire 1700 except the light redirecting means 2036 is not a lens as was the case in the luminaire 1700, but rather a prism with a reflective coating 2038 on its face. This arrangement converts a luminaire that ordinarily emits light vertically in FIG. 20 into one that emits light horizontally.

The above-described luminaires are not symmetric through any vertical plane in the figures portraying them in cross-section. Thus, it is likely that the light emerging from the apertures at the tops of the luminaires will not be distributed symmetrically over angles about the vertical in these figures. To achieve a symmetric distribution of light, two such luminaires that are mirror images of each other can be joined together such that they emit light out a single aperture.

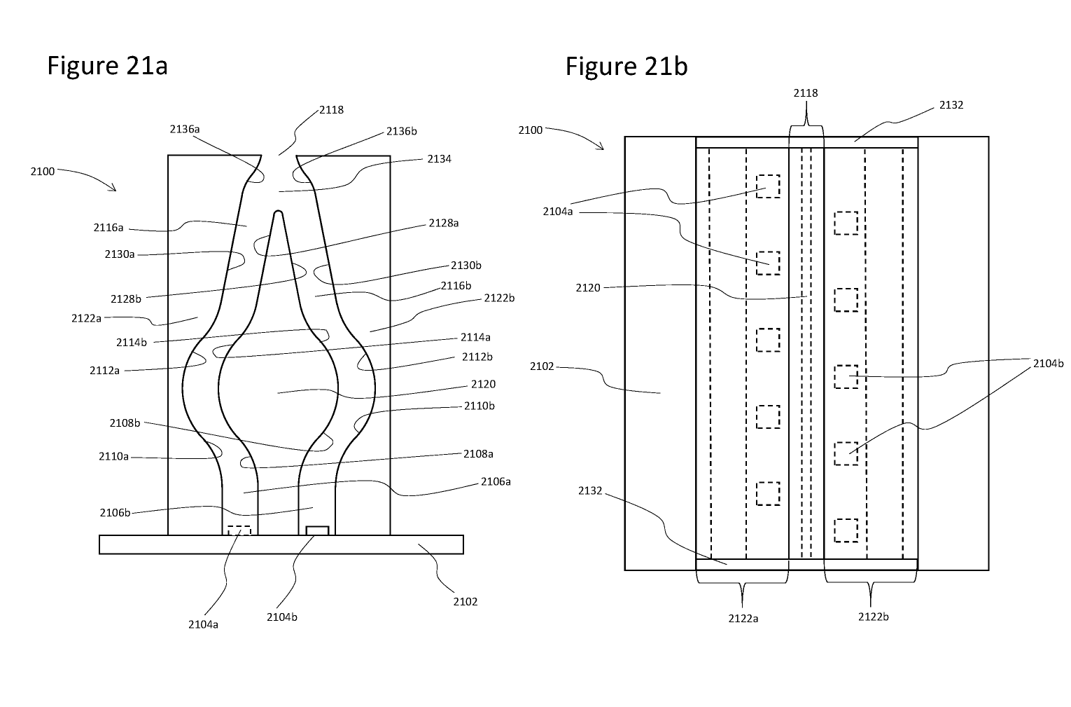

FIGS. 21A-21B illustrate various aspects of a luminaire 2100. FIG. 21A illustrates a cross-section and FIG. 21B illustrates a plan view of the luminaire 2100. Two rows of LEDs 2104a and 2104b emit light into two cavities 2106a and 2106b respectively. These cavities function in a similar manner to cavity 604 in the luminaire 600. Reflective surfaces 2108a, 2110a, 2112a, 2114a above cavity 2106a, and reflective surfaces 2108b, 2110b, 2112b, 2114b above cavity 2106b function in the same way as reflective surfaces 608, 610, 612, 614 of the luminaire 600. Cavities 2116a, 2116b function in much the same way as cavity 616 in the luminaire 600 except that reflective cavity walls 2128a, 2130a, 2128b, 2130b of the luminaire 2100 are tilted from the vertical such that cavities 2116a, 2116b join together to direct light into a single cavity 2134 that is delineated by reflective surfaces 2136a, 2136b. Light entering cavity 2134 from cavities 2116a, 2116b is directed upward and out aperture 2118. Optionally cavities 2106a, 2106b, the spaces bounded by reflective surfaces 2108a, 2108b, 2110a, 2110b, 2112a, 2112b, 2114a, 2114b and cavities 2116a, 2116b, 2134 may be bounded on their ends by reflective walls 2132 as shown in FIG. 21b.

The above-described luminaires all utilized straight lines of LEDs, for instance LEDs 104 shown in FIG. 1b. However, the lines of LEDs utilized may be bent or two lines of LEDs lined up along different axes may be joined together to form a single otherwise continuous line.

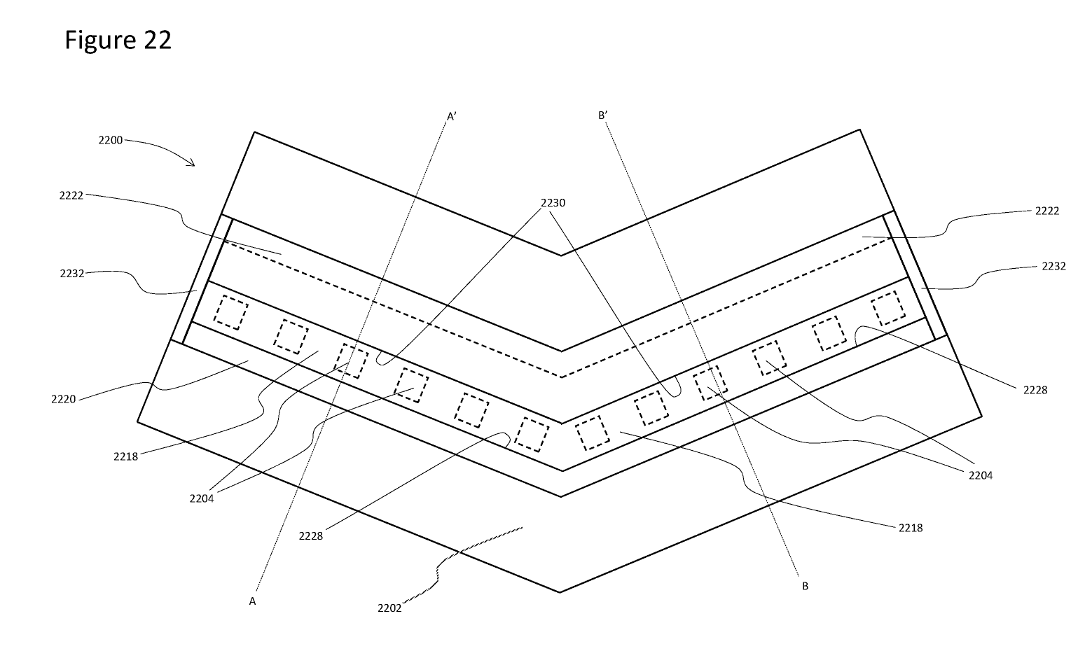

FIG. 22 illustrates various aspects of a luminaire 2200. The luminaire 2200 is similar to the luminaire 100 in that cross-sections of luminaire 2200 along axes A-A′ and B-B′ are identical to that of the luminaire 100 and aperture 2218 functions in an identical manner to aperture 118 in the luminaire 100. However, the luminaire 2200 is different in that the line of LEDs 2104 is bent yielding a bent pattern of output light through aperture 2218.

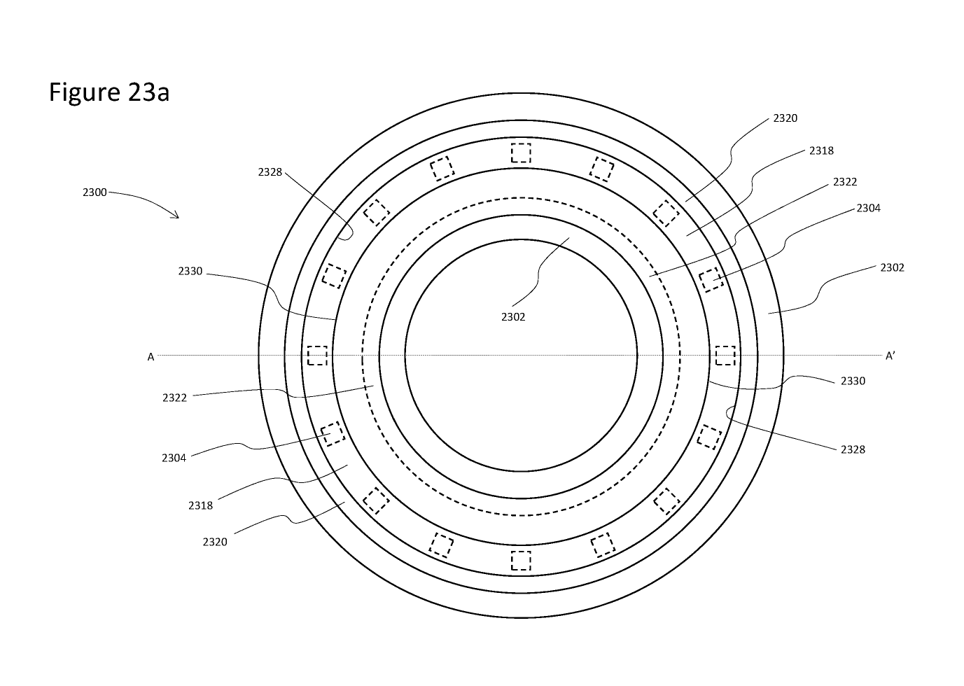

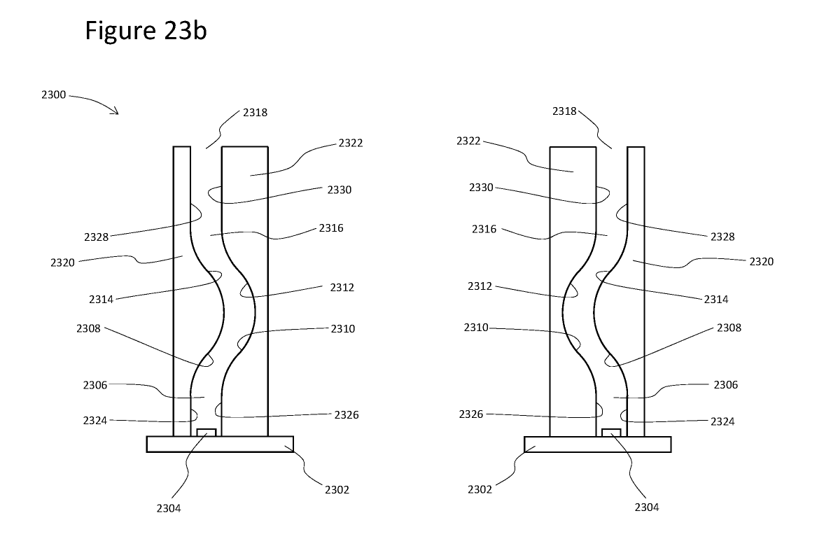

FIGS. 23A-23B illustrate various aspects of a luminaire 2300 having a curved line of LEDs 2304. FIG. 23A illustrates a plan view and FIG. 23B illustrates a cross-section of the luminaire 2300, showing a “left” side and a “right” side of the luminaire 2300 along axis A-A′ of FIG. 23A. For these aspects, the line of LEDs 2304 is joined at the ends to form a circle. The substrate 2302, LEDs 2304, cavity 2306, reflective surfaces 2308, 2310, 2312, 2314 and cavity 2316 perform the same functions as substrate 602, LEDs 604, cavity 606, reflective surfaces 608, 610, 612, 614 and cavity 616 do in the luminaire 600.

### Examples

Example 1—A luminaire is provided. The luminaire comprises a substrate, a plurality of discrete light sources, a cavity between a first body member and a second body member, and an aperture. The plurality of discrete light sources are attached to the substrate along a length of the luminaire and are configured to emit light. At least a portion of light emitted by the plurality of discrete light sources is emitted in a direction normal to the substrate. The cavity extends along the length of the luminaire and is positioned to receive all light emitted by the plurality of discrete light sources. The first body member comprises a protrusion which comprises a first light reflective surface adjacent the cavity. The first light reflective surface is positioned such that all the light emitted by the plurality of discrete light sources in the direction normal to the substrate strikes the first light reflective surface and is then reflected from the first light reflective surface before encountering any other surface of the luminaire. The second body member comprises a recess which includes a second light reflective surface adjacent the cavity. The second light reflective surface is positioned such that a majority of the light emitted by the plurality of discrete light sources in the direction normal to the substrate strikes the second light reflective surface after striking and being reflected from the first light reflective surface. The aperture extends along a length of the cavity opposite the substrate and is positioned to allow light reflected from the second light reflecting surface to subsequently exit the luminaire.

Example 2—The luminaire of Example 1, wherein the plurality of discrete light sources comprises a plurality of light emitting diodes.

Example 3—The luminaires of Examples 1 or 2, further comprising air within the cavity.

Example 4—The luminaires of Examples 1, 2 or 3, wherein the first body member extends along the length of the luminaire, is positioned opposite the second body member and further comprises at least one of the following: a metal material; and a plastic material.

Example 5—The luminaires of Examples 1, 2, 3 or 4, wherein the second body member extends along the length of the luminaire, is positioned opposite the first body member and further comprises at least one of the following: a metal material; and a plastic material.

Example 6—The luminaires of Examples 1, 2, 3, 4 or 5, wherein the protrusion extends along the length of the cavity, the recess extends along the length of the cavity and the protrusion is opposite the recess.

Example 7—The luminaires of Examples 1, 2, 3, 4, 5, or 6, wherein a cross-section of the first body member is uniform along the length of the cavity.

Example 8—The luminaires of Examples 1, 2, 3, 4, 5, 6 or 7, wherein a cross-section of the second body member is uniform along the length of the cavity.

Example 9—The luminaires of Examples 1, 2, 3, 4, 5, 6, 7 or 8, wherein the first body member further comprises at least one additional light reflective surface.

Example 10—The luminaire of Example 9, wherein the second body member further comprises at least one additional light reflective surface.

Example 11—The luminaire of Example 10, wherein at least one of the following comprises a diffusely reflective surface: the first light reflective surface; the at least one additional light reflective surface of the first body member; the second light reflective surface; and the at least one additional light reflective surface of the second body member.

Example 12—The luminaire of Example 10, wherein each of the following comprise diffusively reflective surfaces: the first light reflective surface; the at least one additional light reflective surface of the first body member; the second light reflective surface; and the at least one additional light reflective surface of the second body member.

Example 13—The luminaire of Example 10, wherein at least one of the following comprises a specularly reflective surface: the first light reflective surface; the at least one additional light reflective surface of the first body member; the second light reflective surface; and the at least one additional light reflective surface of the second body member.

Example 14—The luminaire of Example 10, wherein at least one of the following comprises a curved surface: the first light reflective surface; the at least one additional light reflective surface of the first body member; the second light reflective surface; and the at least one additional light reflective surface of the second body member.

Example 15—The luminaires of Examples 1, 2, 3, 4, 5, 6, 7, 8, 9, 10, 11, 12 or 13, wherein at least one of the following comprises a curved surface: the first light reflecting surface; and the second light reflecting surface.

Although the various aspects of the luminaires have been described herein in connection with certain disclosed aspects, many modifications and variations to those aspects may be implemented. Also, where materials are disclosed for certain components, other materials may be used. Furthermore, according to various aspects, a single component may be replaced by multiple components, and multiple components may be replaced by a single component, to perform a given function or functions. The foregoing description and the appended claims are intended to cover all such modifications and variations as falling within the scope of the disclosed aspects.

While this invention has been described as having exemplary designs, the described invention may be further modified within the spirit and scope of the disclosure. This application is therefore intended to cover any variations, uses, or adaptations of the invention using its general principles.

Any patent, patent application, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A luminaire, comprising:
a substrate;
a plurality of discrete light sources which are attached to the substrate along a length of the luminaire and configured to emit light, wherein at least a portion of light emitted by the plurality of discrete light sources is emitted in a direction normal to the substrate;
a cavity between a first body member and a second body member, wherein the cavity extends along the length of the luminaire and is positioned to receive all light emitted by the plurality of discrete light sources, wherein:
the first body member comprises a protrusion, wherein the protrusion comprises a first light reflective surface adjacent the cavity, wherein the first light reflective surface is positioned such that all the light emitted by the plurality of discrete light sources in the direction normal to the substrate strikes the first light reflective surface and is then reflected from the first light reflective surface before encountering any other surface of the luminaire; and
the second body member comprises a recess, wherein the recess comprises a second light reflective surface adjacent the cavity, wherein the second light reflective surface is positioned such that a majority of the light emitted by the plurality of discrete light sources in the direction normal to the substrate strikes the second light reflective surface after striking and being reflected from the first light reflective surface; and
an aperture extending along a length of the cavity opposite the substrate, wherein the aperture is positioned to allow light reflected from the second light reflecting surface to subsequently exit the luminaire.

2. The luminaire of claim 1, wherein the plurality of discrete light sources comprises a plurality of light emitting diodes.

3. The luminaire of claim 1, further comprising air within the cavity.

4. The luminaire of claim 1 wherein the first body member extends along the length of the luminaire, is positioned opposite the second body member and further comprises at least one of the following:
a metal material; and
a plastic material.

5. The luminaire of claim 1, wherein the second body member extends along the length of the luminaire, is positioned opposite the first body member and further comprises at least one of the following:
a metal material; and
a plastic material.

6. The luminaire of claim 1, wherein:
the protrusion extends along the length of the cavity;
the recess extends along the length of the cavity; and
the protrusion is opposite the recess.

7. The luminaire of claim 1, wherein a cross-section of the first body member is uniform along the length of the cavity.

8. The luminaire of claim 1, wherein a cross-section of the second body member is uniform along the length of the cavity.

9. The luminaire of claim 1, wherein the first body member further comprises at least one additional light reflective surface.

10. The luminaire of claim 9, wherein the second body member further comprises at least one additional light reflective surface.

11. The luminaire of claim 10, wherein at least one of the following comprises a diffusely reflective surface:
the first light reflective surface;
the at least one additional light reflective surface of the first body member;
the second light reflective surface; and
the at least one additional light reflective surface of the second body member.

12. The luminaire of claim 10, wherein each of the following comprise diffusively reflective surfaces:
the first light reflective surface;
the at least one additional light reflective surface of the first body member;
the second light reflective surface; and
the at least one additional light reflective surface of the second body member.

13. The luminaire of claim 10, wherein at least one of the following comprises a specularly reflective surface:
the first light reflective surface;
the at least one additional light reflective surface of the first body member;
the second light reflective surface; and
the at least one additional light reflective surface of the second body member.

14. The luminaire of claim 10, wherein at least one of the following comprises a curved surface:
the first light reflective surface;
the at least one additional light reflective surface of the first body member;
the second light reflective surface; and
the at least one additional light reflective surface of the second body member.

15. The luminaire of claim 1, wherein at least one of the following comprises a curved surface:
the first light reflecting surface; and
the second light reflecting surface.
